(19) United States
(12) Patent Application Publication
(10) Pub. No.: US 2026/0262658 A1
(43) Pub. Date: Sep. 10, 2026

(54) INSECT REPELLENT COMPOSITION

(71) Applicant: TAMBA LABS, Aix-en-Provence (FR)

(72) Inventor: Doudou TAMBA, Aix-en-Provence (FR)

(21) Appl. No.: 19/167,376

(22) PCT Filed: Mar. 20, 2024
(86) PCT No.: PCT/FR2024/050340

§ 371 Date: Sep. 21, 2025

(30) Foreign Application Priority Data
Mar. 21, 2023 (FR) FR23/02618

(51) Int. Cl. A01N 65/28; A01N 25/02; A01N 25/34; A01N 27/00; A01N 31/06; A01N 43/90; D06M 13/03; D06M 13/148; D06M 13/165; D06M 16/00

(52) U.S. Cl. CPC A01N 65/28; A01N 25/02; A01N 25/34; A01N 27/00; A01N 31/06; A01N 43/90; D06M 13/03; D06M 13/148; D06M 13/165; D06M 16/00

(57) ABSTRACT

An insect repellent composition comprising:—p-menthane-3,8-diol and/or an essential oil selected from lemon eucalyptus essential oil and Eucalyptus globulus essential oil, —a repellent agent selected from beta-caryophyllene and eucalyptol, —an oil and—a solvent, and which is characterized in that it further comprises Hyptis suaveolens essential oil.

The present invention relates to a composition that repels insects, in particular mosquitoes.

According to the WHO (2017), more than 17% of infectious diseases originate from vector-borne diseases, with more than one million deaths each year. Mosquitoes are the main vectors of these diseases, more specifically those of the genera Aedes, Anopheles and Culex, which transmit to humans: malaria, dengue, chikungunya virus fever, Zika virus fever, Rift Valley fever, yellow fever, West Nile fever, filariasis, as well as various encephalitis. The number of people exposed to the risk of contracting dengue is estimated at more than 3.9 billion in over 129 countries, making it the most widespread viral infection, while malaria accounts for around 219 million cases worldwide and causes more than 400,000 deaths each year, most of them occurring in children under the age of five.

Although the majority of transmitted diseases occur in tropical and subtropical endemic regions, international travel, together with expanding urbanization and globalization, have increased their prevalence in territories that were previously unaffected. This is the case in Europe, which in recent years has seen the appearance on its territory of certain arbovirus-vector mosquitoes such as Aedes albopictus. This mosquito currently represents a major risk in France, as it continues to spread into new regions. In addition to transmitting diseases, mosquitoes may also be a source of nuisance, disrupting outdoor activities. Their bites may furthermore lead to secondary infections, itching, irritation, allergic reactions, or pain.

Among the various means implemented to combat vector-borne diseases transmitted by insects, in particular mosquitoes, protection by repellent effect constitutes a strategy of choice. Indeed, repellency prevents insect bites and thus the spread of the aforementioned diseases. Consequently, there is a constant need for improvement of repellent compositions against disease-vector insects.

Repellent compositions may be provided in various forms such as sprays, lotions, wipes, and sticks for topical application in order to protect the skin from disease-carrying insects.

It is also known to impregnate textile materials (for example clothing, bedding, mosquito nets, upholstery fabrics) with repellent compositions in order to provide protection against disease-vector insects:
either by wearing the treated garment,
or by protecting one's environment with a treated mosquito net, bedding, or upholstery fabric.

Therefore, various treatments for textile materials have been developed to confer repellent properties against disease-vector insects. These treatments consist of impregnating the textile material with a repellent composition, which may, for example, be provided in the form of a spray containing repellent active agents.

Furthermore, repellent compositions may also be used for aerial diffusion via suitable devices enabling their evaporation or atomization.

With regard to repellent active agents for combating mosquitoes, synthetic insecticides are intensively used. The most effective molecule for repelling mosquitoes is N,N-diethyl-m-toluamide (hereinafter abbreviated “DEET”), either for cutaneous use or for spatial diffusion (spray). Other compounds used as insecticides include pyrethroids (permethrin and 8-permethrin). These synthetic compounds (amides, imides, piperidines, phthalates, and permethrins) induce toxic effects of varying severity on the central nervous system. The immediate toxicity of most of these chemical products is generally low, but their use may, in the long term, seriously harm public health, particularly in relation to fertility and cancer.

While pyrethroids are less toxic to humans than DEET, which is not recommended for children under 12 years of age, mosquito resistance to these products has also been reported in 27 sub-Saharan countries. Intensive use of chemical insecticides has led to the development of resistance. The major problem posed by mosquitoes is that they inexorably adapt to the insecticides placed on the market, mainly due to prolonged exposure times and the high doses used.

The development of such insecticide resistance among various mosquito strains makes it imperative to devise alternative, less toxic methods. Research is being conducted into natural repellents, which could provide interesting solutions in mosquito control. Pyrethroids, which are the most widely used insecticides today, were originally natural molecules derived from pyrethrum, itself extracted from chrysanthemum flowers, before chemists succeeded in producing the stabilized molecules that are used today.

The harmful effects of synthetic products have rekindled the need to search for alternatives for the control of harmful and disease-vector mosquitoes. In this respect, plant extracts—particularly tropical plants, which have a long history as important components in traditional medicine and human nutrition—may be considered.

Thus, there is a real need to provide insect repellent compositions, in particular against mosquitoes, that comprise natural constituents, for example plant extracts, and that exhibit the longest possible protection time, at least several hours.

The inventor of the present invention has quite surprisingly discovered a synergistic effect between an oil and a mixture comprising p-menthane-3,8-diol (hereinafter abbreviated “PMD”) or an essential oil selected from Lemon eucalyptus essential oil and Eucalyptus globulus essential oil, together with a repellent agent selected from beta-caryophyllene and eucalyptol, to obtain a novel insect repellent composition exhibiting a total protection time significantly improved compared with what would normally be expected from the constituents used in this repellent composition.

The inventor has thus found that the combination of an oil with a mixture containing PMD and/or an essential oil selected from Lemon eucalyptus essential oil and Eucalyptus globulus essential oil, and a repellent agent selected from beta-caryophyllene and eucalyptol, makes it possible to obtain a repellent composition whose total protection time is very high compared to repellent compositions known to date and currently available on the market. The repellent composition according to the invention is therefore highly effective in terms of protection against insects, in particular against mosquitoes.

A first object of the invention is an insect repellent composition comprising at least:
PMD and/or at least one essential oil selected from Lemon eucalyptus essential oil and Eucalyptus globulus essential oil,
at least one repellent agent selected from beta-caryophyllene and eucalyptol, a solvent,
said repellent composition being characterized in that it further comprises at least one oil.

Beta-caryophyllene is one of the most abundant terpenes in nature. It is found notably in clove, black pepper, cultivated hemp, basil, oregano, lavender, rosemary, black cumin, and cinnamon. It is considered safe by the European Food Safety Authority as a food additive, flavor enhancer, cosmetic additive, and aromatic additive.

PMD is a monoterpene-type organic compound present in very small amounts in the essential oil of Lemon eucalyptus leaves (Corymbia citriodora or Eucalyptus citriodora).

The repellent composition according to the invention has the advantage of being able to comprise only natural constituents.

The oil may be selected from vegetable oils, synthetic oils, and semi-synthetic oils. By “semi-synthetic oil” is meant a vegetable oil that has been functionalized to obtain desired properties.

The oil may be selected from mineral white oils, vegetable oils (derived from flowers, fruits, vegetables, trees, cereals, oilseeds, etc.), animal oils, synthetic oils, silicone oils, and fluorinated oils.

When it is a vegetable oil, it may, for example, be selected from sweet almond oil, coconut oil, copra oil, castor oil, jojoba oil, olive oil, rapeseed oil, peanut oil, sunflower oil, wheat germ oil, corn germ oil, soybean oil, cottonseed oil, alfalfa oil, poppy seed oil, pumpkin seed oil, evening primrose oil, millet oil, barley oil, rye oil, safflower oil, bancoul nut oil, passionflower oil, hazelnut oil, palm oil, shea butter, apricot kernel oil, camellia seed oil, calophyllum oil, sisymbrium oil, avocado oil, calendula oil, and oils derived from flowers or vegetables.

The oil may also be selected from esterified vegetable oils.

The oil may be selected from animal-derived oils, such as squalene and squalane.

The oil may be selected from mineral oils, such as paraffin oil, vaseline oil, and isoparaffins.

The oil may be selected from synthetic oils, in particular from fatty acid esters such as butyl myristate, propyl myristate, cetyl myristate, isopropyl palmitate, butyl stearate, hexadecyl stearate, isopropyl stearate, octyl stearate, isocetyl stearate, dodecyl oleate, hexyl laurate, propylene glycol dicaprylate, hexyldecanol, hexyldecyl laurate, or from esters derived from lanolin acid such as isopropyl lanolate, isocetyl lanolate, as well as monoglycerides, diglycerides, and triglycerides of fatty acids such as glyceryl triheptanoate, alkyl benzoates, polyalphaolefins, polyolefins such as polyisobutene, synthetic isoalkanes such as isohexadecane and isododecane, perfluorinated oils, and silicone oils. Among the latter, particular mention may be made of dimethylpolysiloxanes, methylphenylpolysiloxanes, amine-modified silicones, fatty acid-modified silicones, alcohol-modified silicones, alcohol- and fatty acid-modified silicones, polyether-modified silicones, epoxy-modified silicones, fluorinated silicones, cyclic silicones, and alkyl-modified silicones.

Preferably, the oil is selected from Carapa procera oil, shea butter, palm kernel/coco glucoside, coco-caprylate/caprate, plant-derived squalane extracted from olive, coconut oil, copra oil, castor oil, peanut oil, and sunflower oil, taken alone or in mixtures thereof.

In this regard, it is recalled that shea butter is an edible vegetable oil extracted from shea nuts.

Most advantageously, the oil is selected from Carapa procera oil and coco-caprylate/caprate, taken alone or in mixtures thereof.

The solvent is preferably water or an alcohol. More specifically, the alcohol may be selected from ethanol, isopropanol, and propanol.

The repellent composition may be in the form of a spray. In this embodiment of the invention, the solvent is an alcohol, preferably an alcohol selected from those described above.

The repellent composition may be in the form of a lotion, a cream, or a body milk. In these embodiments of the invention, the solvent is water.

In one embodiment of the invention, the repellent composition comprises a mixture of Lemon eucalyptus essential oil and Eucalyptus globulus essential oil.

In one embodiment of the invention, the repellent composition comprises:
PMD,
at least one repellent agent selected from beta-caryophyllene and eucalyptol,
at least one oil, preferably an oil selected from those described above,
a solvent, preferably a solvent selected from those described above.

In one embodiment of the invention, the repellent composition comprises:
at least one essential oil selected from Lemon eucalyptus essential oil and Eucalyptus globulus essential oil,
at least one repellent agent selected from beta-caryophyllene and eucalyptol,
at least one oil, preferably an oil selected from those described above,
a solvent, preferably a solvent selected from those described above.

In one embodiment of the invention, the repellent composition comprises:
at least one essential oil selected from Lemon eucalyptus essential oil and Eucalyptus globulus essential oil,
at least one repellent agent selected from beta-caryophyllene and eucalyptol,
at least one oil, preferably an oil selected from those described above,
a solvent, preferably a solvent selected from those described above.

In one embodiment of the invention, the repellent composition comprises:
Lemon eucalyptus essential oil,
Beta-caryophyllene,
Carapa procera oil and/or coco-caprylate/caprate,
a solvent, preferably a solvent selected from those described above.

Most advantageously, the repellent composition further comprises Hyptis suaveolens essential oil. The plant Hyptis suaveolens originates from tropical America and is widely distributed in Africa, tropical Asia, and Australia. The main volatile compounds contained in the leaves of this plant are beta-caryophyllene, eucalyptol, sabinene, bergamotene, terpinolene, humulene, and limonene.

The inventor has indeed quite surprisingly discovered a synergistic effect between Hyptis suaveolens essential oil, an oil (preferably an oil selected from those described above), and a mixture comprising PMD and/or at least one essential oil selected from Lemon eucalyptus essential oil and Eucalyptus globulus essential oil, and a repellent agent selected from beta-caryophyllene and eucalyptol, to obtain a novel insect repellent composition exhibiting a protection time significantly improved compared with what would normally be expected given the constituents used in this composition.

The inventor has thus found that the combination of Hyptis suaveolens essential oil with an oil (preferably an oil selected from those described above) and a mixture containing PMD and/or an essential oil selected from Lemon eucalyptus essential oil and Eucalyptus globulus essential oil, and a repellent agent selected from beta-caryophyllene and eucalyptol, makes it possible to obtain a repellent composition whose total protection time is very high compared to repellent compositions known to date and currently available on the market. The repellent composition according to this preferred embodiment of the invention is therefore highly effective in terms of protection against insects, and in particular against mosquitoes.

The repellent composition according to the invention may further comprise at least one additional constituent selected from emulsifiers, surfactants, thickeners, film-forming agents, gelling agents, opacifiers, emulsion stabilizers, humectants, antioxidants, preservatives, fragrances, and ultraviolet filters, taken alone or in combination.

The emulsifier may be selected from fatty alcohols and esters, fatty acids and esters, ethoxylated fatty alcohols, polysaccharide emulsifiers (for example carrageenan), natural gums (for example Arabic gum, guar gum, and xanthan gum), polyol esters (for example polysorbates), emulsifying polymers (for example celluloses and carbomers), taken alone or in combination.

Preferably, it is cetyl alcohol.

The surfactant may be selected from anionic, cationic, amphoteric, or non-ionic surfactants that are topically acceptable and commonly used in the field of dermocosmetics.

Among the anionic surfactants usable in the repellent compositions according to the invention, mention may be made of sulfonate, carboxylate, and phosphate salts such as potassium cetyl phosphate, glyceryl stearate citrate, glyceryl monooleate, and diethylhexyl sulfosuccinate.

Among the cationic surfactants usable in the repellent compositions according to the invention, mention may be made of quaternary ammoniums (for example benzethonium chloride, cetrimide, cetylpyridinium chloride), lauric acid, and myristyl alcohol.

Among the amphoteric surfactants usable in the repellent compositions according to the invention, mention may be made of betaines, amino acid derivatives, and imidazole derivatives such as lauramidopropyl betaine, coco betaine, and cocoyl hydroxyethyl imidazoline.

Among the non-ionic surfactants usable, mention may be made of polyoxyethylenes, alkanolamides, and oligopeptides such as polysorbates, sorbitan monostearate, coco glucoside, and sucrose laurate.

The thickener may be selected from carrageenans, alginates, silicates, and natural, synthetic, or semi-synthetic homopolymers or copolymers with thickening properties, such as xanthan gum, karaya gum, cellulose, hydroxyethylcellulose, and pectin, taken alone or in combination.

The film-forming agent may be selected from natural, synthetic, and semi-synthetic homopolymers or copolymers that are film-forming (for example polyols or fatty alcohols such as guar gum, hydroxyethylcellulose, polyglyceryl methacrylate, fructose, gelatin, glycerin, maltodextrin, methylcellulose, paraffin), taken alone or in combination.

The gelling agent may be selected from gelling polyols and polymers (for example carbomers, sodium carboxymethylcellulose, carrageenan, and chitosan), taken alone or in combination.

The opacifier may be selected from calcium silicates, colorants, ethylene glycol palmitostearate, octyldodecanol, titanium oxide, and zinc stearate, taken alone or in combination.

The emulsion stabilizer may be selected from natural, synthetic, and semi-synthetic polymers (fatty alcohols, cellulose, polysaccharides, such as cetyl stearyl alcohol, sodium carboxymethylcellulose, carrageenan), taken alone or in combination.

The humectant may be selected from butylene glycol, propylene glycol, polyethylene glycol, ammonium alginate, butylene glycol, cyclomethicone, glycerin, polydextrose, propylene glycol, sodium hyaluronate, sodium lactate, sorbitol, tagatose, trehalose, triacetin, and triethanolamine, taken alone or in combination.

The antioxidant may be selected from derivatives of vitamins, minerals, thiols, and polyphenols (for example tocopherols, sodium sulfite, sodium thiosulfate, propyl gallate), taken alone or in combination.

The preservative may be selected from mineral and organic derivatives (for example sorbic acid, parabens, nitrites, sulfites), taken alone or in combination.

The fragrance may be selected from vanillin, any natural plant extract, or any plant

The ultraviolet filter may be selected from titanium dioxide and zinc oxide, diethylamino hydroxybenzoyl hexyl benzoate, ethylhexyl triazone, phenylbenzimidazole sulfonic acid dioxide, bis-ethylhexyloxyphenol methoxyphenyl triazine, taken alone or in combination.

The repellent composition according to the invention may comprise, in weight percentages relative to the total weight of said composition:
between 5% and 30% of PMD and/or at least one essential oil selected from Lemon eucalyptus essential oil and Eucalyptus globulus essential oil,
between 5% and 30% of at least one repellent agent selected from beta-caryophyllene and eucalyptol,
between 5% and 30% of at least one oil, preferably an oil selected from those described above,
q.s. (quantum satis) solvent, preferably a solvent selected from those described above.

“Q.s.” stands for “quantum satis,” meaning that the weight percentage of solvent in the repellent composition is such that, when added to the percentages of all the other constituents of said repellent composition, the total equals 100%.

Advantageously, the repellent composition according to the invention may further comprise between 0.5% and 10% of Hyptis suaveolens essential oil.

The repellent composition according to the invention may further comprise at least one additional constituent (preferably an additional constituent such as described above), the weight percentage of which may range from 0.1% to 5%. When the repellent composition comprises several additional constituents, the total of the weight percentages of the additional constituents may advantageously range from 0.2% to 30%.

In one embodiment of the invention, the repellent composition according to the invention comprises, in weight percentages relative to the total weight of said composition:
between 5% and 30% of PMD and/or at least one essential oil selected from Lemon eucalyptus essential oil and Eucalyptus globulus essential oil,
between 5% and 30% of at least one repellent agent selected from beta-caryophyllene and eucalyptol,
between 5% and 30% of at least one oil, preferably an oil selected from those described above,
optionally between 0.5% and 10% of Hyptis suaveolens essential oil,
optionally between 0.1% and 30% of at least one additional constituent, preferably an additional constituent selected from those described above,
q.s. solvent, preferably a solvent selected from those described above.

In one embodiment of the invention, the repellent composition according to the invention comprises, in weight percentages relative to the total weight of said composition:
between 5% and 30% of PMD and/or at least one essential oil selected from Lemon eucalyptus essential oil and Eucalyptus globulus essential oil,
between 5% and 30% of at least one repellent agent selected from beta-caryophyllene and eucalyptol,
between 5% and 30% of at least one oil, preferably an oil selected from Carapa procera oil, shea butter, palm kernel/coco glucoside, coco-caprylate/caprate, plant-derived squalane extracted from olive, coconut oil, copra oil, castor oil, peanut oil, and sunflower oil, taken alone or in mixtures thereof,
optionally between 0.5% and 10% of Hyptis suaveolens essential oil,
optionally between 0.1% and 30% of at least one additional constituent, q.s. solvent, preferably water or an alcohol.

In one embodiment of the invention, the repellent composition according to the invention comprises, in weight percentages relative to the total weight of said composition:
between 5% and 30% of PMD,
between 5% and 30% of at least one repellent agent selected from beta-caryophyllene and eucalyptol,
between 5% and 30% of at least one oil, preferably an oil selected from those described above,
optionally between 0.5% and 10% of Hyptis suaveolens essential oil,
optionally between 0.1% and 30% of at least one additional constituent, preferably an additional constituent selected from those described above,
q.s. solvent, preferably a solvent selected from those described above.

In one embodiment of the invention, the repellent composition according to the invention comprises, in weight percentages relative to the total weight of said composition:
between 5% and 30% of at least one essential oil selected from Lemon eucalyptus essential oil and Eucalyptus globulus essential oil,
between 5% and 30% of at least one repellent agent selected from beta-caryophyllene and eucalyptol,
between 5% and 30% of at least one oil, preferably an oil selected from those described above,
optionally between 0.5% and 10% of Hyptis suaveolens essential oil,
optionally between 0.1% and 30% of at least one additional constituent, preferably an additional constituent selected from those described above,
q.s. solvent, preferably a solvent selected from those described above.

In one embodiment of the invention, the repellent composition comprises:
between 5% and 30% of Lemon eucalyptus essential oil,
between 5% and 30% of beta-caryophyllene,
between 5% and 30% of Carapa procera oil and/or coco-caprylate/caprate,
optionally between 0.5% and 10% of Hyptis suaveolens essential oil,
optionally between 0.1% and 30% of at least one additional constituent, preferably an additional constituent selected from those described above,
q.s. solvent, preferably a solvent selected from those described above.

The present invention also relates to a process for manufacturing the repellent composition as described above. The manufacturing process comprises at least the following steps:
an active base is prepared by carrying out steps a) and b):
a) PMD and/or at least one essential oil selected from Lemon eucalyptus essential oil and Eucalyptus globulus essential oil is mixed with at least one repellent agent selected from beta-caryophyllene and eucalyptol, and optionally Hyptis suaveolens essential oil,
b) to the mixture from step a) is added at least one oil, preferably an oil selected from those described above, so as to obtain the active base,
the repellent composition is finalized as follows:
2a) when the solvent is water:
the optional additional lipophilic constituents are added to the active base,
an aqueous phase is prepared by adding to the water the optional additional hydrophilic constituents,
said aqueous phase is mixed with the active base to which the optional lipophilic additional constituents may have been added, so as to obtain the repellent composition in the form of an oil-in-water emulsion,
2b) when the solvent is alcohol:
the active base is mixed with alcohol and the optional additional constituents so as to obtain the repellent composition in a sprayable form.

At the end of step b), the active base is present in the form of oily microdroplets. More specifically, the PMD and/or at least one essential oil selected from Lemon eucalyptus essential oil and Eucalyptus globulus essential oil, at least one repellent agent selected from beta-caryophyllene and eucalyptol, and optionally Hyptis suaveolens essential oil, constitute

It is entirely within the competence of a person skilled in the art to determine whether the optional additional constituents are lipophilic or hydrophilic and whether they should therefore be added to the active base, to the water, or to the alcohol.

When the solvent is alcohol, the constituents of the active base readily mix with the alcohol. There is no phase separation problem.

Moreover, in this embodiment of the invention, once sprayed onto the skin, the repellent composition provides a film-forming effect on the skin, which may additionally yield an efficiency gain of 13.3% through simple friction.

When the solvent is water, the repellent composition is in the form of an oil-in-water emulsion. The repellent composition comprises microparticles containing the active base, which are dispersed in the continuous aqueous phase. These microparticles spread easily over the skin, and the constituents of the active base are released more slowly than when the repellent composition contains alcohol as a solvent.

Therefore, the total protection times are longer when the repellent composition comprises water as the solvent and is thus in the form of an oil-in-water emulsion, compared to when the repellent composition comprises alcohol as the solvent.

Preferably, steps a) and b) are carried out at a temperature between 25° C. and 60° C. For example, the temperature is 45° C. A water bath may be used for this purpose.

Steps a) and b) are advantageously carried out with a dispersion and homogenization device, for example an Ultra-Turrax® device.

During step a), the mixing speed may range from 1,500 revolutions per minute to 7,000 revolutions per minute. In one embodiment of the invention, it is 5,000 revolutions per minute.

During step b), the mixing speed may range from 1,500 revolutions per minute to 18,000 revolutions per minute. In one embodiment of the invention, it is 13,000 revolutions per minute.

The duration of step a) may range from 1 minute to 10 minutes. In one embodiment of the invention, it is 3 minutes.

The duration of step b) may range from 1 minute to 10 minutes. In one embodiment of the invention, it is 7 minutes.

When the solvent is water, the optional additional lipophilic constituents are added to the active base by subjecting the mixture to a mixing speed ranging from 1,500 revolutions per minute to 18,000 revolutions per minute, for a duration of 1 to 10 minutes, and at a temperature between 25° C. and 60° C. In one embodiment of the invention, the mixing speed is 13,000 revolutions per minute, the duration of this step is 3 minutes, and the temperature of the mixture is 45° C. (obtained using a water bath). This step is advantageously carried out with a dispersion and homogenization device, for example an Ultra-Turrax® device.

The optional hydrophilic additional constituents are added to the water by subjecting the mixture to a mixing speed ranging from 1,500 revolutions per minute to 18,000 revolutions per minute, for a duration of 1 to 10 minutes, and at a temperature between 25° C. and 60° C. In one embodiment of the invention, the mixing speed is 14,000 revolutions per minute, the duration of this step is 5 minutes, and the temperature of the mixture is 45° C. (obtained using a water bath). This step is advantageously carried out with a dispersion and homogenization device, for example an Ultra-Turrax® device.

Finally, said aqueous phase is mixed with the active base, to which the optional lipophilic additional constituents may have been added, by subjecting the mixture to a mixing speed ranging from 1,500 revolutions per minute to 18,000 revolutions per minute, for a duration of 1 to 10 minutes, and at a temperature between 25° C. and 60° C. In one embodiment of the invention, the mixing speed is 13,000 revolutions per minute, the duration of this step is 3 minutes, and the temperature of the mixture is 45° C. (obtained using a water bath). This step is advantageously carried out with a dispersion and homogenization device, for example an Ultra-Turrax® device.

When the solvent is alcohol, the active base is mixed with alcohol by subjecting the mixture to a mixing speed ranging from 1,500 revolutions per minute to 10,000 revolutions per minute, for a duration of 1 to 10 minutes, and at a temperature between 20° C. and 35° C. In one embodiment of the invention, the mixing speed is 5,000 revolutions per minute, the duration of this step is 3 minutes, and the temperature of the mixture is ambient temperature (about 20° C.). This step is advantageously carried out with a dispersion and homogenization device, for example an Ultra-Turrax® device.

The repellent composition according to the invention may also be manufactured using an ultrasound device (or other mechanical stirring devices). This device makes it possible to stir the constituents of the mixtures in the different steps of the manufacturing process.

The repellent composition according to the invention is preferably repellent against mosquitoes. For example, it may concern the following mosquito species: Aedes aegypti, Culex pipiens, and Anopheles gambiae.

The repellent composition may be applied directly to the skin.

In another embodiment of the invention, the repellent composition according to the invention may be diffused into the air using a suitable device (for example a device plugged into an electrical outlet).

The present invention also relates to a method for repellent treatment against insects (preferably mosquitoes) of a textile material, characterized in that at least one repellent composition according to the invention as described above is sprayed onto at least a portion of said textile material.

The textile material may be selected from natural textile materials such as cotton, feather, down; synthetic textile materials such as polyesters, nylon, acrylics; or mixed textile materials.

Within the scope of the present invention, the term “textile material” refers to any textile material selected, for example, from:
non-woven textiles (for example felts),
woven textiles (for example warp and weft fabrics), or
knitted textiles (for example knits),
which are composed of fibers, filaments, or yarns, taken alone or in mixtures thereof, of natural and/or synthetic origin.

The fibers may be spun, carded, or twisted. The natural fibers, filaments, or yarns may be of plant or animal origin and thus selected from cotton, wool, silk, jute, linen, hemp, and viscose. The synthetic fibers, filaments, or yarns may also be synthetic in origin and selected from polyamides, aramids, polyesters, polyacrylonitriles, aramids, polybenzimidazole, polyether-ether-ketone, polyphenylene sulfides, polyacrylics, chlorofibers, polyolefins such as polypropylene or polyethylene.

The textile material treated with the repellent composition according to the invention may be used in various fields such as:
bedding (quilts, duvets, pillows, sheets, pillowcases, blankets);
clothing;
furnishings (mosquito nets, carpets, curtains);
storage (packaging covers for clothing, bedding items such as quilts and blankets, or furnishings).

In one embodiment of the invention, between 0.01 and 50 g/m², preferably between 0.01 and 20 g/m², of repellent composition according to the invention is sprayed onto said textile material.

Spraying may be carried out manually or automatically, for example with a mechanical, pneumatic, electrical, or compressed-air sprayer.

The repellent compositions according to the invention may be ready-to-use or diluted in a suitable excipient before being sprayed onto the textile. It is within the competence of a person skilled in the art to determine any dilutions to be carried out before spraying the repellent composition according to the invention onto the textile.

The repellent treatment process according to the invention may consist of domestic use. For example, the user sprays the repellent composition onto a garment, a bedding or furnishing item, a storage cover, or a mosquito net to be protected from insects (for example mosquitoes).

In another embodiment, the repellent treatment process according to the invention is implemented on an industrial line. The repellent composition according to the invention may thus be sprayed onto a textile material during an industrial process, for example an industrial process for manufacturing clothing, bedding or furnishing items, storage covers, or mosquito nets, so as to treat them before their use.

The textile material may be selected from clothing, bedding or furnishing items, storage covers, or mosquito nets.

The present invention therefore also relates to a textile material that has been treated by spraying a repellent composition according to the invention as described above. The textile material may be a textile material as described above.

The present invention also relates to a product that has been treated by spraying a repellent composition according to the invention as described above, preferably in the amounts described above. The product may be a product as described above, for example a garment, a bedding or furnishing item, a storage cover, or a mosquito net. The invention will now be described using the following non-limiting examples.

### Experimental Part:

Experiments were carried out to measure the total protection time obtained with test compositions, namely repellent compositions according to the invention and comparative compositions, after their application to the skin and exposure to mosquitoes.

During these experiments, mosquitoes of the species Anopheles gambiae and Aedes aegypti were used. The mosquito colony was maintained in a chamber at a temperature of 27° C. with a humidity rate of 80% and a photoperiod of 12 hours of light and 12 hours of darkness. The mosquito larvae were fed with fish food. The emerged adults were placed in cubic cages measuring 45 cm per side and fed with a 10% sugar solution. The females used during the experiments came from batches of mosquitoes aged 4 to 7 days post-emergence.

The experimental protocol implemented was that described in the Guidelines for efficacy testing of mosquito repellents on human skin (WHO/HTM/NTD/WHOPES/2009.4), WHO, 2009.

This was the “arm-in-cage” test. Volunteers (men and women aged 20 to 45 years) who had applied a test composition to their forearms (i.e., the area extending from the wrist to the elbow, approximately 600 cm² of skin) successively placed their arms into the mosquito cage.

The total protection time corresponded to the time between the application of the tested composition on the skin and the first mosquito bite and/or the landing and maintenance on the skin of two mosquitoes probing without biting.

A-Synergistic effect of the combination of beta-caryophyllene, Lemon eucalyptus essential oil, with coco-caprylate/caprate:

### Example 1

Table 1 below details the weight percentages of the constituents of a first repellent composition according to the invention (“IQ-A1”).

TABLE 1

| IQ-A1 | Mass % |
|---|---|
| 95° Ethyl alcohol | QSP |
| Lemon eucalyptus essential oil | 20% |
| Coco-caprylate | 10% |
| Vanillin powder | 10% |
| Beta-caryophyllene | 0.50% |

The total protection time of the first repellent composition according to the invention “IQ-A1” was 3 hours. This total protection time is highly effective for a repellent composition.

Table 2 below details the weight percentages of the constituents of a first comparative composition (“C-A1”), namely a composition identical to the composition IQ-A1 except that it lacked coco-caprylate/caprate.

TABLE 2

| C-A1 | Mass % |
|---|---|
| 95° Ethyl alcohol | QSP |
| Lemon eucalyptus essential oil | 20% |
| Coco-caprylate | 0% |
| Vanillin powder | 10% |
| Beta-caryophyllene | 0.50% |

The total protection time of the first comparative composition “C-A1” was 1 hour.

Table 3 below details the weight percentages of the constituents of a second comparative composition (“C-A2”), namely a composition identical to composition IQ-A1 except that it lacked beta-caryophyllene and Lemon eucalyptus essential oil.

TABLE 3

| C-A2 | Mass % |
|---|---|
| 95° Ethyl alcohol | QSP |
| Lemon eucalyptus essential oil | 0% |
| Coco-caprylate | 10% |
| Vanillin powder | 10% |
| Beta-caryophyllene | 0% |

The total protection time of the second comparative composition “C-A2” was zero minutes. In other words, with the second comparative composition, there was no protection against mosquitoes during this experiment.

The synergy between the active constituents, namely:
the mixture of Lemon eucalyptus essential oil and beta-caryophyllene on the one hand, and
coco-caprylate/caprate on the other hand,
was calculated by comparing the total protection time results of composition IQ-A1 and the comparative compositions C-A1 and C-A2.

If the total protection time of composition IQ-A1 was greater than that expected according to Colby's formula, there was synergy. If it was lower, there was antagonism, and if it was equal, the mixture of Lemon eucalyptus essential oil and beta-caryophyllene and coco-caprylate/caprate acted without interaction between them.

Colby's formula is:
[Math. 1]
X is the total protection time of the first comparative composition C-A1, namely 1 hour. Y is the total protection time of the second comparative composition C-A2, namely 0 minutes.

E is the expected total protection time of the mixture of Lemon eucalyptus essential oil and beta-caryophyllene, as well as coco-caprylate/caprate, without synergy between them, namely 1 hour.

The total protection time of the first repellent composition according to the invention IQ-A1 was 3 hours, therefore three times greater than the expected protection time of 1 hour.

This experiment clearly demonstrates the synergistic effect between the mixture of Lemon eucalyptus essential oil and beta-caryophyllene with coco-caprylate/caprate. In other words, the association of coco-caprylate/caprate with a mixture containing Lemon eucalyptus essential oil and beta-caryophyllene significantly improves the total protection time (namely threefold) of the repellent composition.

### Example 2

Table 4 below details the weight percentages of the constituents of a second repellent composition according to the invention (“IQ-A2”).

TABLE 4

| IQ-A2 | Mass % |
|---|---|
| 95° Ethyl alcohol | QSP |
| Lemon eucalyptus essential oil | 25% |
| Coco-caprylate | 4% |
| Vanillin powder | 10% |
| Beta-caryophyllene | 5% |

The total protection time of the second repellent composition according to the invention “IQ-A2” was 3 hours. This total protection time is highly effective for a repellent composition.

Table 5 below details the weight percentages of the constituents of a third comparative composition (“C-A3”), namely a composition identical to composition IQ-A2 except that it lacked coco-caprylate/caprate.

TABLE 5

| C-A3 | Mass % |
|---|---|
| 95° Ethyl alcohol | QSP |
| Lemon eucalyptus essential oil | 25% |
| Coco-caprylate | 0% |
| Vanillin powder | 10% |
| Beta-caryophyllene | 5% |

The total protection time of the third comparative composition “C-A3” was 1.6 hours.

Table 6 below details the weight percentages of the constituents of a fourth comparative composition (“C-A4”), namely a composition identical to composition IQ-A2 except that it lacked beta-caryophyllene and Lemon eucalyptus essential oil.

TABLE 6

| C-A4 | Mass % |
|---|---|
| 95° Ethyl alcohol | QSP |
| Lemon eucalyptus essential oil | 0% |
| Coco-caprylate | 4% |
| Vanillin powder | 10% |
| Beta-caryophyllene | 0% |

The total protection time of the fourth comparative composition “C-A4” was zero minutes. In other words, with the fourth comparative composition, there was no protection against mosquitoes during this experiment.

The synergy between the active constituents, namely:
the mixture of Lemon eucalyptus essential oil and beta-caryophyllene on the one hand, and
coco-caprylate/caprate on the other hand,
was calculated by comparing the total protection time results of composition IQ-A2 and the comparative compositions C-A3 and C-A4.

Using Colby's formula detailed above, the expected total protection time of the mixture of Lemon eucalyptus essential oil and beta-caryophyllene, as well as coco-caprylate/caprate, without synergy between them, was 1.6 hours.

The total protection time of the second repellent composition according to the invention IQ-A2 was 3 hours, thus nearly twice the expected protection time of 1.6 hours.

This experiment also demonstrates the synergistic effect between the mixture of Lemon eucalyptus essential oil and beta-caryophyllene and coco-caprylate/caprate. In other words, the association of coco-caprylate/caprate with a mixture containing Lemon eucalyptus essential oil and beta-caryophyllene significantly improves the total protection time (i.e., nearly twofold) of the repellent composition.

B-Synergistic effect of the combination of beta-caryophyllene, Lemon eucalyptus essential oil, with Carapa procera oil:

### Example 3

Table 7 below details the weight percentages of the constituents of a third repellent composition according to the invention (“IQ-B1”).

Table 7 below details the weight percentages of the constituents of a third repellent composition according to the invention (“IQ-B1”).

TABLE 7

| IQ-B1 | Mass % |
|---|---|
| 95° Ethyl alcohol | QSP |
| Lemon eucalyptus essential oil | 20% |
| Coco-caprylate | 10% |
| Vanillin powder | 10% |
| Beta-caryophyllene | 5% |

The total protection time of the third repellent composition according to the invention “IQ-B1” was 3.5 hours. This total protection time is highly effective for a repellent composition.

Table 8 below details the weight percentages of the constituents of a fifth comparative composition (“C-B1”), namely a composition identical to composition IQ-B1 except that it lacked Carapa procera oil.

TABLE 8

| C-B1 | Mass % |
|---|---|
| 95° Ethyl alcohol | QSP |
| Lemon eucalyptus essential oil | 20% |
| Coco-caprylate | 0% |
| Vanillin powder | 10% |
| Beta-caryophyllene | 5% |

The total protection time of the fifth comparative composition “C-B1” was 1.5 hours.

Table 9 below details the weight percentages of the constituents of a sixth comparative composition (“C-B2”), namely a composition identical to composition IQ-A3 except that it lacked beta-caryophyllene and Lemon eucalyptus essential oil.

TABLE 9

| C-B2 | Mass % |
|---|---|
| 95° Ethyl alcohol | QSP |
| Lemon eucalyptus essential oil | 0% |
| Coco-caprylate | 10% |
| Vanillin powder | 10% |
| Beta-caryophyllene | 0% |

The total protection time of the sixth comparative composition “C-B2” was 0.2 hours.

The synergy between the active constituents, namely:
the mixture of Lemon eucalyptus essential oil and beta-caryophyllene on the one hand, and Carapa procera oil on the other hand, was calculated by comparing the total protection time results of composition IQ-B1 and comparative compositions C-B1 and C-B2.

Using Colby's formula detailed above, the expected total protection time of the mixture of Lemon eucalyptus essential oil and beta-caryophyllene, as well as the vegetable oil coco-caprylate/caprate, without synergy between them, was 1.697 hours.

The total protection time of the third repellent composition according to the invention IQ-B1 was 3.5 hours, thus twice the expected protection time of 1.697 hours.

This experiment also demonstrates the synergistic effect between the mixture of Lemon eucalyptus essential oil and beta-caryophyllene and Carapa procera oil. In other words, the association of Carapa procera oil with a mixture containing Lemon eucalyptus essential oil and beta-caryophyllene significantly improves the total protection time (i.e., twofold) of the repellent composition.

### Example 4

Table 10 below details the weight percentages of the constituents of a fourth repellent composition according to the invention (“IQ-B2”).

TABLE 10

| IQ-B2 | % by weight |
|---|---|
| Water | Q.s. |
| Xanthan gum | 1% |
| Potassium cetyl phosphate | 1% |
| Glyceryl stearate citrate | 1% |
| Cetyl stearyl alcohol | 4% |
| Carapa procera oil | 15% |
| Lemon eucalyptus essential oil | 20% |
| Tocopherol | 1% |
| Sorbic acid | 3% |
| Vanillin powder | 5% |
| Beta-caryophyllene | 5% |

The total protection time of the fourth repellent composition according to the invention “IQ-B2” was 3.8 hours. This total protection time is highly effective for a repellent composition.

Table 11 below details the weight percentages of the constituents of a seventh comparative composition (“C-B3”), namely a composition identical to composition IQ-B2 except that it lacked Carapa procera oil.

TABLE 11

| C-B3 | % by weight |
|---|---|
| Water | Q.s. |
| Xanthan gum | 1% |
| Potassium cetyl phosphate | 1% |
| Glyceryl stearate citrate | 1% |
| Cetyl stearyl alcohol | 4% |
| Carapa procera oil | 0% |
| Lemon eucalyptus essential oil | 20% |
| Tocopherol | 1% |
| Sorbic acid | 3% |
| Vanillin powder | 5% |
| Beta-caryophyllene | 5% |

The total protection time of the seventh comparative composition “C-B3” was 2 hours.

Table 12 below details the weight percentages of the constituents of an eighth comparative composition (“C-B4”), namely a composition identical to composition IQ-B2 except that it lacked beta-caryophyllene and Lemon eucalyptus essential oil.

TABLE 12

| C-B4 | % by weight |
|---|---|
| Water | Q.s. |
| Xanthan gum | 1% |
| Potassium cetyl phosphate | 1% |
| Glyceryl stearate citrate | 1% |
| Cetyl stearyl alcohol | 4% |
| Carapa proceraoil | 15% |
| Lemon eucalyptus essential oil | 0% |
| Tocopherol | 1% |
| Sorbic acid | 3% |
| Vanillin powder | 5% |
| Beta-caryophyllene | 0% |

The total protection time of the eighth comparative composition “C-B4” was 0.5 hours.

The synergy between the active constituents, namely:
the mixture of Lemon eucalyptus essential oil and beta-caryophyllene on the one hand, and Carapa procera oil on the other hand, was calculated by comparing the total protection time results of composition IQ-B2 and comparative compositions C-B3 and C-B4.

Using Colby's formula detailed above, the expected total protection time of the mixture of Lemon eucalyptus essential oil and beta-caryophyllene, as well as Carapa procera oil, without synergy between them, was 2.49 hours.

The total protection time of the fourth repellent composition according to the invention IQ-B2 was 3.8 hours, thus higher than the expected protection time of 2.49 hours.

This experiment also demonstrates the synergistic effect between the mixture of Lemon eucalyptus essential oil and beta-caryophyllene and Carapa procera oil. In other words, the association of Carapa procera oil with a mixture containing Lemon eucalyptus essential oil and beta-caryophyllene improves the total protection time of the repellent composition.

C-Synergistic effect of the combination of beta-caryophyllene, Lemon eucalyptus essential oil, Carapa procera oil, and Hyptis suaveolens essential oil:

### Example 5

Table 13 below details the weight percentages of the constituents of a fifth repellent composition according to the invention (“IQ-C1”).

TABLE 13

| IQ-C1 | % by weight |
|---|---|
| Water | Q.s. |
| Xanthan gum | 1% |
| Potassium cetyl phosphate | 1% |
| Glyceryl stearate citrate | 1% |
| Cetyl stearyl alcohol | 4% |
| Carapa procera oil | 10% |
| Lemon eucalyptus essential oil | 20% |
| Tocopherol | 1% |
| Sorbic acid | 3% |
| Vanillin powder | 5% |
| Hyptis suaveolens essential oil | 2% |
| Beta-caryophyllene | 5% |

The total protection time of the fifth repellent composition according to the invention “IQ-C1” was 10.5 hours. This total protection time of more than 10 hours is very remarkable for a repellent composition. Such a protection duration has never been achieved with repellent compositions known in the prior art.

Table 14 below details the weight percentages of the constituents of a ninth comparative composition (“C-C1”), namely a composition identical to composition IQ-C1 except that it lacked Hyptis suaveolens essential oil.

TABLE 14

| C-C1 | % by weight |
|---|---|
| Water | Q.s. |
| Xanthan gum | 1% |
| Potassium cetyl phosphate | 1% |
| Glyceryl stearate citrate | 1% |
| Cetyl stearyl alcohol | 4% |
| Carapa procera oil | 10% |
| Lemon eucalyptus essential oil | 20% |
| Tocopherol | 1% |
| Sorbic acid | 3% |
| Vanillin powder | 5% |
| Hyptis suaveolens essential oil | 0% |
| Beta-caryophyllene | 5% |

The total protection time of the ninth comparative composition “C-C1” was 3.8 hours.

Table 15 below details the weight percentages of the constituents of a tenth comparative composition (“C-C2”), namely a composition identical to composition IQ-C1 except that it lacked beta-caryophyllene, Lemon eucalyptus essential oil, and Carapa procera oil.

TABLE 15

| C-C2 | % by weight |
|---|---|
| Water | Q.s. |
| Xanthan gum | 1% |
| Potassium cetyl phosphate | 1% |
| Glyceryl stearate citrate | 1% |
| Cetyl stearyl alcohol | 4% |
| Carapa procera oil | 0% |
| Lemon eucalyptus essential oil | 0% |
| Tocopherol | 1% |
| Sorbic acid | 3% |
| Vanillin powder | 5% |
| Hyptis suaveolens essential oil | 2% |
| Beta-caryophyllene | 0% |

The total protection time of the tenth comparative composition “C-C2” was 0 minutes.

The synergy between the active constituents, namely:
the mixture of Lemon eucalyptus essential oil, beta-caryophyllene, and Carapa procera oil on the one hand, and Hyptis suaveolens essential oil on the other hand, was calculated by comparing the total protection time results of composition IQ-C1 and comparative compositions C-C1 and C-C2.

Using Colby's formula detailed above, the expected total protection time of the mixture of Lemon eucalyptus essential oil, beta-caryophyllene, and Carapa procera oil, as well as Hyptis suaveolens essential oil, without synergy between them, was 3.8 hours.

The total protection time of the fifth repellent composition according to the invention IQ-C1 was 10.5 hours, thus 2.8 times greater than the expected protection time of 3.8 hours.

This experiment also demonstrates the synergistic effect between the mixture of Lemon eucalyptus essential oil and beta-caryophyllene, Carapa procera oil, and Hyptis suaveolens essential oil. In other words, the association of Hyptis suaveolens essential oil with Carapa procera oil and a mixture containing Lemon eucalyptus essential oil and beta-caryophyllene significantly improves the total protection time (i.e., 2.8 times better) of the repellent composition.

### Example 6

Table 16 below details the weight percentages of the constituents of a sixth repellent composition according to the invention (“IQ-C2”).

TABLE 16

| IQ-C2 | Mass % |
|---|---|
| 95° Ethyl alcohol | QSP |
| Lemon eucalyptus essential oil | 20% |
| Carapa procera oil | 10% |
| Vanillin powder | 5% |
| Beta-caryophyllene | 5% |
| Hyptis suaveolens essential oil | 1% |

The total protection time of the sixth repellent composition according to the invention “IQ-C2” was 6 hours. This total protection time is indeed highly effective for a repellent composition.

Table 17 below details the weight percentages of the constituents of an eleventh comparative composition (“C-C3”), namely a composition identical to composition IQ-C2 except that it lacked Hyptis suaveolens essential oil.

TABLE 17

| C-C3 | Mass % |
|---|---|
| 95° Ethyl alcohol | QSP |
| Lemon eucalyptus essential oil | 20% |
| Carapa procera oil | 10% |
| Vanillin powder | 5% |
| Beta-caryophyllene | 5% |
| Hyptis suaveolens essential oil | 0% |

The total protection time of the eleventh comparative composition “C-C3” was 3.5 hours.

Table 18 below details the weight percentages of the constituents of a twelfth comparative composition (“C-C4”), namely a composition identical to composition IQ-C2 except that it lacked beta-caryophyllene, Lemon eucalyptus essential oil, and Carapa procera oil.

TABLE 18

| C-C4 | Mass % |
|---|---|
| 95° Ethyl alcohol | QSP |
| Lemon eucalyptus essential oil | 0% |
| Carapa procera oil | 0% |
| Vanillin powder | 5% |
| Beta-caryophyllene | 0% |
| Hyptis suaveolens essential oil | 1% |

The total protection time of the twelfth comparative composition “C-C4” was 0 minutes.

The synergy between the active constituents, namely:
the mixture of Lemon eucalyptus essential oil, beta-caryophyllene, and Carapa procera oil on the one hand, and Hyptis suaveolens essential oil on the other hand, was calculated by comparing the total protection time results of composition IQ-C2 and comparative compositions C-C3 and C-C4.

Using Colby's formula detailed above, the expected total protection time of the mixture of Lemon eucalyptus essential oil, beta-caryophyllene, and Carapa procera oil, as well as Hyptis suaveolens essential oil, without synergy between them, was 3.5 hours.

The total protection time of the sixth repellent composition according to the invention IQ-C2 was 6 hours, thus 1.7 times greater than the expected protection time of 3.5 hours.

This experiment also demonstrates the synergistic effect between the mixture of Lemon eucalyptus essential oil and beta-caryophyllene, Carapa procera oil, and Hyptis suaveolens essential oil. In other words, the association of Hyptis suaveolens essential oil with Carapa procera oil and a mixture containing Lemon eucalyptus essential oil and beta-caryophyllene significantly improves the total protection time (i.e., 1.7 times better) of the repellent composition.

### Example 7

Table 19 below details the weight percentages of the constituents of a seventh repellent composition according to the invention (“IQ-C3”).

TABLE 19

| IQ-C3 | Mass % |
|---|---|
| 95° Ethyl alcohol | QSP |
| Lemon eucalyptus essential oil | 20% |
| Carapa procera oil | 10% |
| Vanillin powder | 5% |
| Beta-caryophyllene | 5% |
| Hyptis suaveolens essential oil | 3% |

The total protection time of the seventh repellent composition according to the invention “IQ-C3” was 8.5 hours. This total protection time of more than 8 hours is indeed highly effective for a repellent composition.

The eleventh comparative composition (“C-C3”) was a composition identical to composition IQ-C3 except that it lacked Hyptis suaveolens essential oil.

As explained above, the total protection time of the eleventh comparative composition “C-C3” was 3.5 hours.

Table 20 below details the weight percentages of the constituents of a thirteenth comparative composition (“C-C5”), namely a composition identical to composition IQ-C3 except that it lacked beta-caryophyllene, Lemon eucalyptus essential oil, and Carapa procera oil.

TABLE 20

| C-C5 | Mass % |
|---|---|
| 95° Ethyl alcohol | QSP |
| Lemon eucalyptus essential oil | 0% |
| Carapa procera oil | 0% |
| Vanillin powder | 5% |
| Beta-caryophyllene | 0% |
| Hyptis suaveolens essential oil | 3% |

The total protection time of the thirteenth comparative composition “C-C5” was 0 minutes.

The synergy between the active constituents, namely:
the mixture of Lemon eucalyptus essential oil, beta-caryophyllene, and Carapa procera oil on the one hand, and Hyptis suaveolens essential oil on the other hand, was calculated by comparing the total protection time results of composition IQ-C3 and comparative compositions C-C3 and C-C5.

Using Colby's formula detailed above, the expected total protection time of the mixture of Lemon eucalyptus essential oil, beta-caryophyllene, and Carapa procera oil, as well as Hyptis suaveolens essential oil, without synergy between them, was 3.5 hours.

The total protection time of the seventh repellent composition according to the invention IQ-C3 was 8.5 hours, thus 2.4 times greater than the expected protection time of 3.5 hours.

This experiment also demonstrates the synergistic effect between the mixture of Lemon eucalyptus essential oil and beta-caryophyllene, Carapa procera oil, and Hyptis suaveolens essential oil. In other words, the association of Hyptis suaveolens essential oil with Carapa procera oil and a mixture containing Lemon eucalyptus essential oil and beta-caryophyllene significantly improves the total protection time (i.e., 2.4 times better) of the repellent composition.

### Example 8

Table 21 below details the weight percentages of the constituents of an eighth repellent composition according to the invention (“IQ-C4”).

TABLE 21

| IQ-C4 | % by weight |
|---|---|
| Water | Q.s. |
| Xanthan gum | 1% |
| Hexyl decanol | 3% |
| Hexyldecyl laurate | 3% |
| Sucrose laurate | 2% |
| Cetyl stearyl alcohol | 1% |
| Carapa procera oil | 10% |
| Lemon eucalyptus essential oil | 15% |
| Tocopherol | 1% |
| Sorbic acid | 2% |
| Vanillin powder | 5% |
| Hyptis suaveolens essential oil | 1% |
| Beta-caryophyllene | 20% |

The total protection time of the eighth repellent composition according to the invention “IQ-C4” was 10.5 hours. Such a total protection duration has never been achieved with repellent compositions known in the prior art.

1. An insect repellent composition comprising at least: p-menthane-3,8-diol (PMD) and/or at least one essential oil selected from lemon eucalyptus essential oil and Eucalyptus globulus essential oil; at least one repellent agent selected from beta-caryophyllene and eucalyptol; a solvent; and at least one oil.

2. The repellent composition according to claim 1, wherein the oil is selected from Carapa procera oil, shea butter, palm kernel/coco glucoside, coco-caprylate/caprate, plant squalane extracted from olive, coconut oil, copra oil, castor oil, peanut oil, and sunflower oil, taken alone or in mixtures thereof.

3. The repellent composition according to claim 2, wherein the oil is selected from Carapa procera oil and coco-caprylate/caprate, taken alone or in mixtures thereof.

4. The repellent composition according to claim 1, wherein the solvent is water or an alcohol.

5. The repellent composition according to claim 4, wherein the alcohol is selected from ethanol, isopropanol, and propanol.

6. The repellent composition according to claim 5, wherein the composition further comprises Hyptis suaveolens essential oil.

7. The repellent composition according to claim 1, wherein it further comprises at least one additional constituent selected from emulsifiers, surfactants, thickeners, film-forming agents, gelling agents, opacifiers, emulsion stabilizers, humectants, antioxidants, preservatives, fragrances, and UV filters.

8. The repellent composition according to claim 7, wherein the additional constituent is selected from cetyl alcohol, tocopherol, and vanillin powder.

9. The repellent composition according to claim 8, comprising, in weight percentages relative to the total weight of said composition:
5% to 30% of lemon eucalyptus essential oil,
5% to 30% of beta-caryophyllene,
5% to 30% of Carapa procera oil and/or coco-caprylate/caprate,
optionally 0.5% to 10% of Hyptis suaveolens essential oil,
optionally 0.1% to 30% of at least one additional constituent,
Q.s. solvent, preferably water or an alcohol.

10. A method for treating a textile material, characterized in that the textile is sprayed with a composition according to any one of claims 1 to 9.
